(19) United States
(12) Patent Application Publication
(10) Pub. No.: US 2026/0195634 A1
(43) Pub. Date: Jul. 9, 2026

(54) ARTIFICIAL INTELLIGENCE-BASED INFERENCE PROCESSING OF DATASTREAM SIGNALS

(71) Applicant: INTERNATIONAL BUSINESS MACHINES CORPORATION, Armonk, NY (US)

(72) Inventors: Weixin XU, San Jose, CA (US); David Alvra WOOD, III, Scarsdale, NY (US); Tadanobu INOUE, Yokohama (JP); Pooja NANJANNAVAR, Houston, TX (US); Philipp SCHUME, Austin, TX (US); Caio Augusto RIBAS PADULA, Flower Mound, TX (US); Joseph FLEURY, Reading, MA (US); Ofir SHANI, San Paulo (BR)

(21) Appl. No.: 19/008,828

(22) Filed: Jan. 3, 2025

(51) Int. Cl. G06N 20/00; G06F 18/241

(52) U.S. Cl. CPC G06N 20/00; G06F 18/241

(57) ABSTRACT

Artificial intelligence-based inference processing is provided which includes training a machine learning classify model to identify whether a length L datastream clip recorded occurrence of a priority event within a fabrication process. The training includes training a machine learning label model to predict labels for unlabeled datastream signal clips of length M for a fabrication process, where L is greater than M and consists of a consecutive sequence of K signal clips of length M, and applying the trained label model to the length L datastream signal clip for the fabrication process to create a list of labels. The training also includes applying label priority in selecting a most appropriate label from among the list of labels, where the selected label identifies whether the length L datastream signal clip recorded occurrence of the priority event within the fabrication process.

### BACKGROUND

One or more aspects relate, in general, to facilitating inference processing within a computing environment, and more particularly to improving artificial intelligence-based inference processing of datastream signals generated from monitoring a fabrication process, such as edge-computing-based inference processing for a welding process.

Industrial metal-to-metal welding operations are one example of a fabrication process where companies are struggling to automate process inspections, such as to detect defects. To prevent costly product recalls, excessive scrap, rework and other costs associated with poor quality welds, companies are looking to automate inspections and identify weld defects earlier and more consistently. Currently, manufacturing processes often use a combination of destructive and non-destructive quality testing methods to determine whether there is a discontinuity or defect with a weld. Destructive testing includes the mechanical disassembly of a weld (e.g., grinding) and chemical etching (e.g., ethanol plus citric acid) to measure fusion parameters. Although accurate, if a defect is discovered using this approach, remediating it requires discarding all welds that have taken place from the time of the discovery to remediation. The process can be very costly and time consuming. Non-destructive testing is largely done by human visual inspection. Occasionally, it is augmented by ultrasound testing, which is also conventionally human driven. Once a defect is discovered and remediated, each weld completed during the time must also be tested. These types of inspections are subjective, expensive, and time consuming.

### SUMMARY

Certain shortcomings of the prior art are overcome, and additional advantages are provided herein through the provision of a method with includes training a machine learning classify model to identify whether a length L datastream clip of a fabrication process recorded occurrence of a priority event within the fabrication process. Training the machine learning classify model includes training a machine learning label model to predict labels for unlabeled datastream signal clips of length M obtained for the fabrication process, where L is greater than M and consists of a consecutive sequence of K signal clips of length M, and where training the machine learning label model uses labeled datastream signal clips of length M, and applying the trained machine learning label model to the length L datastream signal clip for the fabrication process to generate a list of labels for the consecutive sequence of K signal clips of the length L datastream signal clip. Training the classify model also includes applying label priority to select a most appropriate label from among the list of labels to apply to the length L datastream signal clip, where the selected label for the length L datastream clip identifies whether the length L datastream signal clip recorded occurrence of a priority event within the fabrication process.

Computer program products and computer systems relating to one or more aspects are also described and claimed herein. Further, services relating to one or more aspects are also described and may be claimed herein.

Additional features and advantages are realized through the techniques described herein. Other embodiments and aspects are described in detail herein and are considered a part of the disclosed inventive aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to include and/or use one or more aspects of the present disclosure;

FIG. 2 depicts one embodiment of a computer program product with inference processing code, in accordance with one or more aspects of the present disclosure;

FIG. 3 depicts one embodiment of an inference processing workflow, in accordance with one or more aspects of the present disclosure;

FIG. 4 depicts another example of a computing environment to include and/or use one or more aspects of the present disclosure;

FIG. 5 depicts one example of machine learning model training, in accordance with one or more aspects of the present disclosure;

FIG. 6 depicts a datastream signal obtained from monitoring a fabrication process, with the datastream signal shown parsed into length L datastream signal clips to facilitate inference processing, in accordance with one or more aspects of the present disclosure;

FIG. 7 depicts one embodiment of training inference processing, including training a machine learning label model to predict labels for unlabeled datastream signal clips of length M, as well as training a machine learning classify model to classify length L datastream signal clips label priority, in accordance with one or more aspects of the present disclosure;

FIGS. 8A-8B depict one detailed embodiment of a fabrication process and system including and/or using one or more aspects of present disclosure; and

FIG. 9 depicts another embodiment of an inference processing workflow, in accordance with one or more aspects of the present disclosure.

### DETAILED DESCRIPTION

Aspects of the present disclosure and certain features, advantages, and details thereof, are explained more fully below with reference to the non-limiting example(s) illustrated in the accompanying drawings. Descriptions of well-known software, systems, devices, processing techniques, tools, etc., are omitted so as not to unnecessarily obscure the disclosure in detail. It should be understood, however, that the detailed description and the specific example(s), while indicating aspects of the disclosure, are given by way of illustration only, and are not by way of limitation. Various substitutions, modifications, additions, and/or arrangements, within the spirit and/or scope of the underlying inventive concepts will be apparent to those skilled in the art for this disclosure. Note further that reference is made below to the drawings, where the same or similar reference numbers used throughout different figures designate the same or similar components. Also, note that numerous inventive aspects and features are disclosed herein, and unless otherwise inconsistent, each disclosed aspect or feature is combinable with any other disclosed aspect or feature as desired for a particular application of the concepts disclosed.

Note also that illustrative embodiments are described below using specific code, designs, architectures, protocols, layouts, schematics, systems, or tools only as examples, and not by way of limitation. Furthermore, the illustrative embodiments are described in certain instances using particular software, hardware, tools, and/or data processing environments only as example for clarity of description. The illustrative embodiments can be used in conjunction with other comparable or similarly purposed structures, systems, applications, architectures, tools, engines, etc. One or more aspects of an illustrative embodiment can be implemented in software, hardware, or a combination thereof.

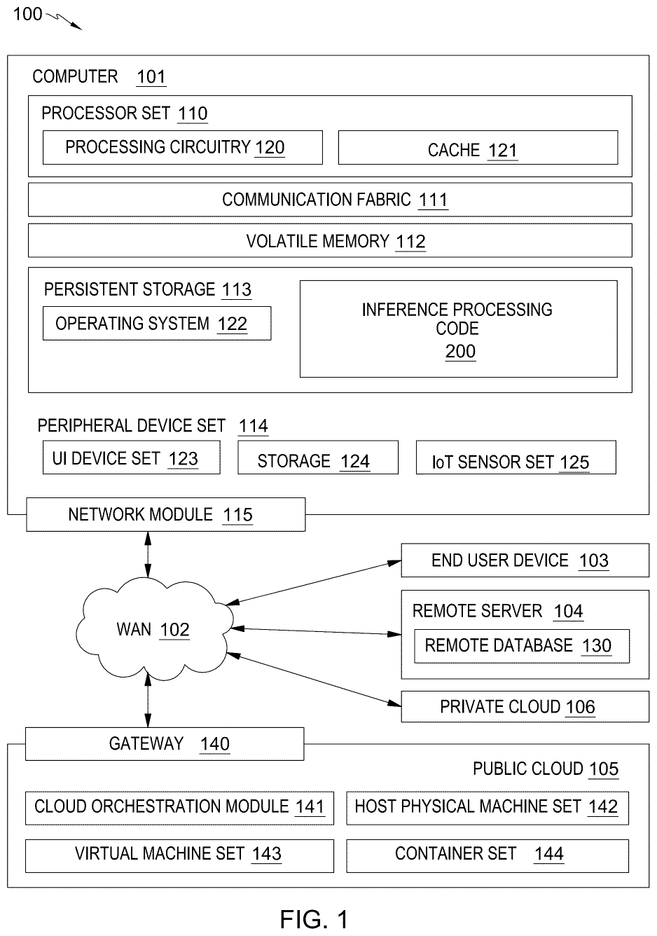

As understood by one skilled in the art, program code, as referred to in this application, can include software and/or hardware. For example, program code in certain embodiments of the present disclosure can utilize a software-based implementation of the functions described, while other embodiments can include fixed function hardware. Certain embodiments combine both types of program code. Examples of program code, also referred to as code, or one or more programs, are depicted in FIG. 1, including operating system 122 and inference processing code 200, which are stored in persistent storage 113.

One or more aspects of the present disclosure are incorporated in, performed and/or used by a computing environment. As examples, the computing environment can be of various architectures and of various types, including, but not limited to: personal computing, client-server, distributed, virtual, emulated, partitioned, non-partitioned, cloud-based, quantum, grid, time-sharing, clustered, peer-to-peer, mobile, having one node or multiple nodes, having one or more processor sets, each with one processor or multiple processors, and/or any other type of environment and/or configuration, etc., that is capable of executing a process (or multiple processes) that, e.g., perform processing, such as disclosed herein. Aspects of the present disclosure are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As illustrated in FIG. 1, computing environment 100 contains an example of an environment for the execution of at least some of the computer code involved in performing the inventive methods, such as inference processing code 200. In addition to code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in data-analytics-based inference processing code 200 includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud computing services and/or microservices (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The computing environment described above is only one example of a computing environment to incorporate, perform and/or use one or more aspects of the present disclosure. Other examples are possible. Further, in one or more embodiments, one or more of the components/modules of FIG. 1 need not be included in the computing environment and/or are not used for one or more aspects of the present disclosure. Further, in one or more embodiments, additional and/or other components/modules can be used. Other variations are possible.

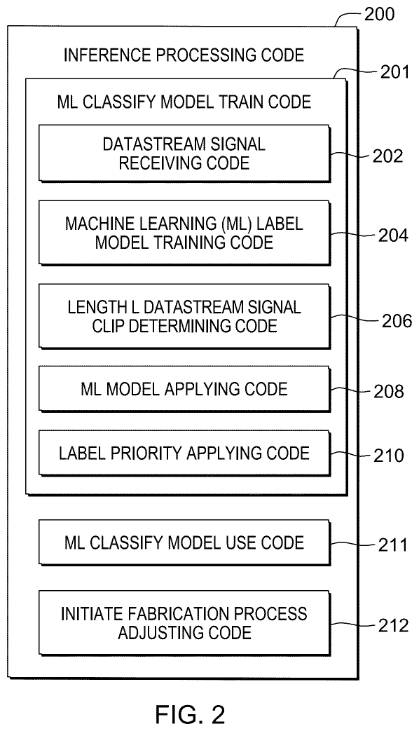

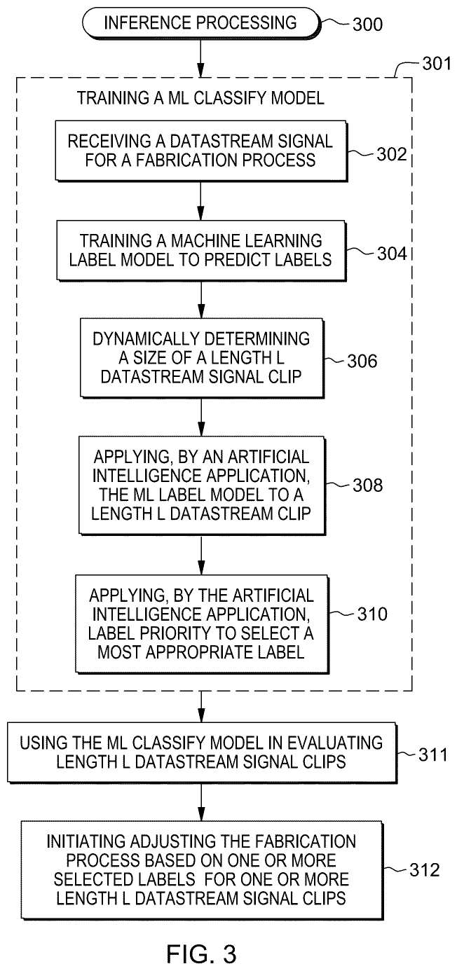

By way of example, one or more embodiments of an inference processing code and workflow are described initially with reference to FIGS. 2-3. FIG. 2 depicts one embodiment of inference processing code 200 that includes code or instructions to perform inference processing, including training the machine learning classify model in accordance with one or more aspects of the present disclosure, and FIG. 3 depicts one embodiment of an inference processing workflow, including training the machine learning classify model, in accordance with one or more aspects of the present disclosure.

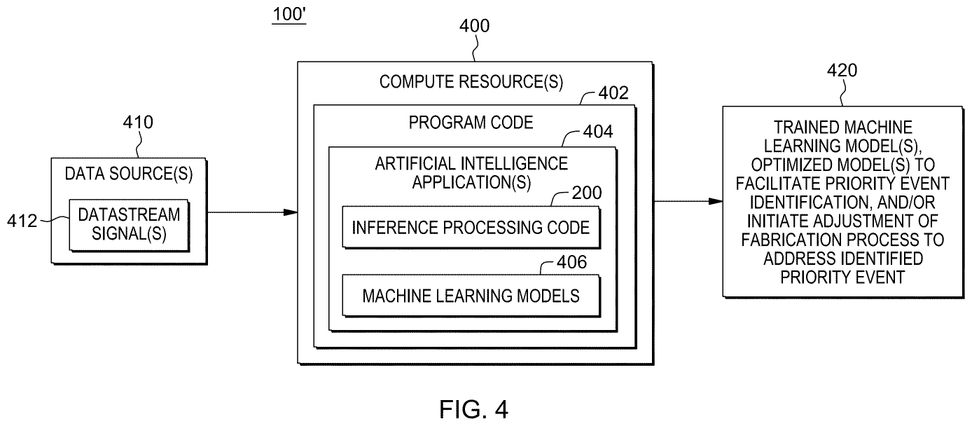

Referring to FIGS. 1-2, inference processing code 200 includes, in one example, various code or sub-modules used to perform processing, in accordance with one or more aspects of the present disclosure. The sub-modules are, e.g., computer-readable program code (e.g., instructions) in computer-readable media (e.g., persistent storage (e.g., persistent storage 113, such as a disk) and/or a cache (e.g., cache 121), as examples). The computer-readable media can be part of a computer program product and can be executed by and/or using one or more computers, such as computer(s) 101 (FIG. 1) and/or computer resource(s) 400 (FIG. 4); one or more processor sets 110 (FIG. 1); processors, such as one or more processors of processor set 110; and/or processing circuitry, such as processing circuity of processor set 110, etc.

As noted, FIG. 2 depicts one embodiment of inference processing code 200 which, in one or more implementations, includes, or facilitates, inference processing in accordance with one or more aspects of the present disclosure, including training (and using) a machine learning (ML) classify model 201 to identify whether a length L datastream clip of a fabrication process recorded occurrence of a priority event within the fabrication process. In the embodiment of FIG. 2, example code of ML classify model train code 201 includes datastream signal receiving code 202 to receive a datastream signal obtained for a fabrication process, and machine learning (ML) label model training code 204 to train a machine learning label model to predict labels for unlabeled datastream signal clips of length M obtained for a fabrication process. Training the machine learning label model uses, in one embodiment, labeled datastream signal clips of length M. In embodiments, ML classify model code 201 also includes length L datastream signal clip determining code 206 to determine or identify an optimal size of the length L datastream signal clip for the received datastream signal, where L is greater than M and consists of a consecutive sequence of K signal clips of length M.

In embodiments, ML classify model code 201 further includes machine learning (ML) label model applying code 208, to apply, by the artificial intelligence application, the trained machine learning label model to the length L datastream signal clip for the fabrication process to create a list of K labels for the length L datastream signal clip. Further, in embodiments, ML classify model code 201 includes label priority applying code 210 to apply, via the artificial intelligence application, label priority to select a most appropriate label from among the list of K labels to apply to the length L datastream signal clip, where the selected label for the length L datastream clip identifies whether the length L datastream signal clip recorded occurrence of a priority event within the fabrication process. In one or more embodiments, inference processing code 200 further includes ML classify model use code 211 to use the trained ML classify model in production during the fabrication process in evaluating length L datastream signal clips, and initiate fabrication process adjusting code 212 to initiate adjusting the fabrication process based, at least in part, on the selected label for the length L datastream signal clip, that is, when the trained machine learning classify model is in use.

Note also that although various code or sub-modules are described herein, inference processing code, such as disclosed, can use, or include, additional, fewer, and/or different code/sub-modules. A particular code can include additional code, including code of other sub-modules, or less code. Further, additional and/or fewer code/sub-modules can be used. Many variations are possible.

In one or more embodiments, the inference processing code is used, in accordance with one or more aspects of the present disclosure, to perform inference processing. FIG. 3 depicts one example of an inference processing workflow 300, such as disclosed herein. The process is executed, in one or more embodiments, by a computer (e.g., computer 101 (FIG. 1), computer resource(s) 400 (FIG. 4)), and/or one or more processor sets, such as a processor or processing circuitry (e.g., of processor set 110 of FIG. 1). In one example, code or instructions implementing the process, are part of a code or module, such as inference processing code 200 of FIGS. 1-2. In other examples, the code can be included in one or more other modules and/or one or more other sub-modules of one or more other modules. Various options are available.

As illustrated in FIG. 3, in one example, inference processing workflow 300 executing on one or more computers (e.g., computer 101 of FIG. 1, computer resource(s) 400 (FIG. 4)), one or more processor sets (e.g., processor set 110 of FIG. 1, such as a processor or processing circuitry of the processor set) performs inference processing such as described herein, which includes, in one or more embodiments, training a machine learning classify model 301 to identify whether a length L datastream clip of a fabrication process recorded occurrence of a priority event within the fabrication process. Training the machine learning classify model 301 includes receiving a datastream signal generated in monitoring a fabrication process 302, and training a machine learning label model to predict labels for unlabeled datastream signal clips of length M for the fabrication process 304, where L is greater than M and consists of a consecutive sequence of K signal clips of length M. Training the machine learning model uses, in one or more embodiments, labeled datastream signal clips of length M. In one or more embodiments, training the machine learning classify model 301 further includes identifying, e.g., dynamically determining, a size of a length L datastream signal clip from the received datastream signal 306.

In embodiments, training the machine learning classify model 301 includes applying, by an artificial intelligence application, the trained machine learning label model to the length L datastream signal clip generated from monitoring the fabrication process to create a list of K labels for the consecutive sequence of K signal clips of the length L datastream signal clip 308. In one or more embodiments, training the machine learning classify model 301 further includes applying, by the artificial intelligence application, label priority to select the most appropriate label from among the list of K labels to apply to the length L datastream signal clip 310. In embodiments, the selected label identifies whether the length L datastream signal clip recorded occurrence of a priority event within the fabrication process. For instance, in one or more embodiments, the selected label identifies whether the length L datastream signal clip recorded occurrence of a defect event within, or resulting from, the fabrication process, and if so, identifies the type of defect that occurred.

In one or more embodiments, inference processing 300 further includes, after training the machine learning classify model 301, using the model in evaluating length L datastream signal clips in production during the fabrication process 311, and initiating adjusting of the fabrication process based, at least in part, on a selected label for a length L datastream signal clip 312. In one example, an action is initiated by automatically sending, for instance, an indication to dynamically adjust one or more parameters of the fabrication process to eliminate occurrence of the priority event during the fabrication process. As an example, the indication is sent by a computer (e.g., computer 101 (FIG. 1)), a processor of a processor set (e.g., processor set 110 (FIG. 1)), and/or processing circuitry of a processor set (e.g., processor set 110) (FIG. 1) and/or a computer resource(s) 400 (FIG. 4) running an artificial intelligence application 404 (that implements, or includes, inference processing code 200), to a computer system, electronic component, etc. of a fabrication system, that receives the indication and automatically initiates the action. As one example only, the fabrication process is a welding process, and the identified defect to be addressed is a type of weld defect.

By way of further example, FIG. 4 depicts another embodiment of a computing environment 100′, which can incorporate, use or implement, one or more aspects of an embodiment of the present disclosure. In one or more embodiments, computing environment 100′ is implemented as part of, or includes, a computing environment such as computing environment 100 described above in connection with FIG. 1. Computing environment 100′ contains one or more computer resources 400, such as one or more computers 101 of FIG. 1, connected to receive (e.g., obtain, access, etc.) data from one or more data sources 410, such as one or more microphones, video cameras and/or monitoring systems operatively located to monitor a fabrication process and provide one or more real-time datastream signals 412, such as one or more audio datastreams and/or video datastreams, generated in monitoring the fabrication process. Note that in this regard, that the datastream signal can be one or more datastream signals generated from monitoring one or more instances of a fabrication process. Further, the fabrication process can be one instance of the fabrication process, and can refer to a particular fabrication process type and/or application, such as a particular type of welding process.

In embodiments, the one or more computer resources 400 execute program code 402 that runs or implements, for instance, one or more artificial intelligence application(s) 404 that execute or include one or more aspects of inference processing code 200, such as disclosed herein. In one or more embodiments, inference processing code 200trains, includes, and/or utilizes, one or more machine learning models 406, which can be part of inference processing code 200 or accessed by inference processing code 200. Inference processing code 200 facilitates training the machine learning models 406 to predict labels for unlabeled datastream signal strips for length M generated from monitoring the fabrication process, where training the machine learning model uses label datastream signal clips of length M, as well as to train a machine learning classify model to identify whether a length L datastream clip of a fabrication process recorded occurrence of a priority event within the fabrication process. As noted, the datastream signal can be an audio and/or video signal generated, for instance, by monitoring a fabrication process. Also as noted, the inference processing code facilitates applying, by the artificial intelligence application(s) 404, the trained machine learning models to a length L datastream signal clip generated from monitoring the fabrication process, where L is greater than M and consists of a consecutive sequence of K signal clips of length L, to create a list of K labels for the consecutive sequence of K signal clips of length L datastream signal clip. Further, the code facilitates applying label priority to select a most appropriate label from among the list of K labels to apply to the length L datastream signal clip, where the selected label identifies whether the length L datastream signal clip recorded occurrence of a priority event within the fabrication process. In one or more embodiments, the list of K labels includes an event label that has a lower priority class than another event label of higher priority class in the list of K labels, and the selected label is the other label of higher priority class in the list of K labels. In one example, the event label of lower priority class is a normal process event label, and the other event label of the higher priority class is a defect event label of a plurality of defect event label types of the higher priority class. In one application, the fabrication process is a welding process, and the plurality defect event labels of the priority class represent different types of potential weld defects.

In one or more embodiments, inference processing code 200 receives the datastream signal for the fabrication process, and identifies a size of the length L datastream signal clip for the received data signal. For instance, in one embodiment, the identifying includes growing the size of the length L datastream signal clip while ensuring that there is only one event label type of a higher priority class of a plurality of event label types of the higher priority class in the longer length L signal clip. In particular, in one embodiment, the inference processing code 200 facilities dynamically determining, based on data analytics, a size of the length L datastream signal clip, where the dynamically determining allows an event label of lower priority class to coexist with an event label type of the higher priority class and ensures that only one type of higher priority event can be within the length L datastream signal clip, and the one type of priority event is one type of priority event of the plurality of priority event types monitored for potentially occurring during the fabrication process.

In one or more embodiments, once the machine learning classify model is trained, inference processing code 200, and/or artificial intelligence application(s) 404, further uses the trained machine learning classify model, including initiating adjusting the fabrication process based on the one or more selected labels for one or more length L datastream signal clips processed. For instance, in one or more embodiments, inference processing code 200, and/or artificial intelligence application(s) 404, initiates or provides one or more actions, recommendations or predictions 420 to, for instance, facilitate machine learning model training, priority event identification, and/or initiating adjusting of the fabrication process to address an identified priority event, for instance, within a fabrication system, such as an automated welding system in one example. For example, an indication to adjust a process parameter can be sent to the fabrication system implementing the fabrication process. As an example, the indication is sent by computer resource 400, such as a computer (e.g., computer 101 of FIG. 1), a processor of a processor set (e.g., processor set 110 (FIG. 1)) and/or processing circuitry of a processor set (e.g., processor set 110) (FIG. 1) to a computing or electronic component that receives the indication and automatically initiates the adjustment action. Alternatively, or additionally, the one or more event indications can be sent directly to the fabrication system that performs the action. Based on initiating the fabrication adjustment, the fabrication process is performed. Many possibilities exist.

In one or more implementations, computing environment 100′ can include, or utilize, one or more networks for interfacing various aspects of computer resource(s) 400, data source(s) 410, as well as one of or more other controllers, components, systems, etc., receiving a result, action, instruction, etc. 420 of the inference processing code 200, and/or artificial intelligence application(s) 404, in a manner that facilitates improved fabrication processing, such as disclosed herein. By way of example, the network(s) can be, for instance, a telecommunications network, a local area network (LAN), a wide area network (WAN), such as the Internet, or a combination thereof, and can include wired, wireless, fiber optic connections, etc. The network(s) can include one or more wired and/or wireless networks that are capable of receiving and transmitting data, including (for instance) training data for one or more machine learning model(s) of the inference processing code, or the artificial intelligence application(s), and an output solution, recommendation, action of the inference processing code, and/or artificial intelligence, such discussed herein.

In one or more implementations, computer resource(s) 400 house and/or execute program code 402 configured to perform computer-implemented methods in accordance with one or more aspects of the present disclosure. By way of example, computer resource(s) 400 can be a computing-system-implemented resource(s). Further, for illustrative purposes only, computer resource(s) 400 in FIG. 4 is depicted as being a single computer resource. This is a non-limiting example of an implementation. In one or more other embodiments, computer resource(s) 400, which implements one or more aspects of processing such as discussed herein, can, at least in part, be implemented in multiple separate computer resources or systems, such as one or more computer resources of a cloud-hosting environment, by way of example.

Briefly described, in one embodiment, computer resource(s) 400 can include one or more processor sets with one or more processors, for instance, central processing units (CPUs). Also, the processor set(s) can include functional components used in the integration of program code, such as functional components to fetch program code from locations in memory, such as cache or main memory, decode program code, and execute program code, access memory for instruction execution, and write results of the executed instructions or code. The processor set(s) can also include a register(s) to be used by one or more of the functional components. In one or more embodiments, the computing resource(s) can include memory, input/output, a network interface, and storage, which can include and/or access, one or more other computing resources and/or databases, as required to implement the inference processing code processing described herein. The components of the respective computing resource(s) can be coupled to each other via one or more buses and/or other connections. Bus connections can be one or more of any of several types of bus structures, including a memory bus or a memory controller, a peripheral bus, an accelerated graphics port, and a processor or local bus, using any of a variety of architectures. By way of example, but not limitation, such architectures can include the Industry Standard Architecture (ISA), the micro-channel architecture (MCA), the enhanced ISA (EISA), the Video Electronic Standard Association (VESA), local bus, and peripheral component interconnect (PCI). As noted, examples of a computer resource(s), or computing system(s) or controller(s), which can implement one or more aspects disclosed are described further herein.

In one or more embodiments, program code 402 includes, executes, accesses, etc., one or more artificial intelligence applications 404, with inference processing code 200, which can train and use machine learning models 406 that embody (in part), or are used by, the inference processing code 200. The artificial intelligence application(s) 404, can be (in part) within an artificial intelligence (AI) agent or AI tool and/or can include, or use, one or more machine learning models that are pretrained using training data that can include a variety of types of datastream signals or datastream signal clips, as well as labeled spectrograms. In one or more embodiments, program code 402 executing on one or more computer resources 400 applies one or more algorithms of, for instance, the artificial intelligence application(s) 404 to generate and train the machine learning model(s) 406, which the program code then utilizes to, for instance, implement one or more aspects of inference processing code 200. In an initialization or learning stage, program code 402 can train the one or more machine learning models 406 using obtained training data to implement, for instance, one or more aspects of the code, functions and/or tools described herein.

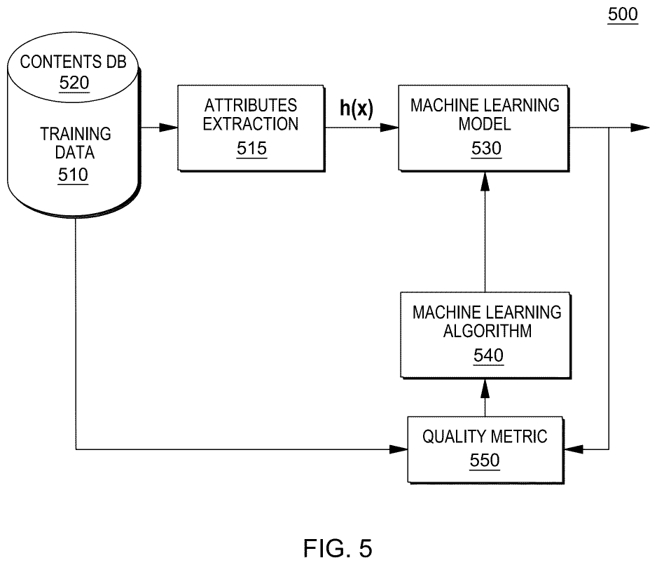

One example of a machine learning training system is depicted in FIG. 5. In one or more embodiments, a machine learning training system 500 can be utilized to perform cognitive analysis of various inputs, including input data, data from one or more sources, repositories, data structures and/or other data. The data can include, at least, unlabeled datastream signal clip data, and labeled datastream signal clips of length M data, such as described herein. Program code, in embodiments of the present disclosure, can perform data analysis to generate data structures, including algorithms utilized by the program code to implement one or more aspects of the inference processing and/or initiate (or perform) an action related thereto. As known, machine learning-based modeling solves problems that cannot be solved by numerical means alone. In one example, program code extracts features/attributes 515 from the training data 510, which can be stored in memory or one or more databases 520. The extracted features can be utilized to develop a predictor function, h(x), also referred to as a hypothesis, which the program code utilizes as a model 530.

In identifying various event states, features, attribute similarities, constraints and/or behaviors indicative of states in the ML training data 510, the program code can utilize various techniques to identify attributes in an embodiment of the present disclosure. Embodiments of the present disclosure utilize varying techniques to select attributes (data attributes, elements, patterns, features, constraints, distribution, etc.), including but not limited to, diffusion mapping, principal component analysis, recursive feature elimination (a brute force approach to selecting attributes), and/or a Random Forest, to select the attributes related to various events. The program code may utilize a machine learning algorithm 540 to train the machine learning model(s) 530 (e.g., the algorithms utilized by the program code), including providing weights for the conclusions, so that the program code can train the predictor functions that comprise the machine learning model(s) 530. The conclusions may be evaluated by a quality metric 550. By selecting a diverse set of ML training data 510, the program code trains the machine learning model(s) 530 to identify and weight various attributes (e.g., data attributes, features, patterns, constraints, distributions, etc.) that correlate to various states or events of a process.

The model generated by the program code can be self-learning as the program code updates the model based on event feedback, as well as from the feedback received from data related to identifying an event. For example, when the program code determines that there is a constraint, event, similarity or pattern (e.g., data attribute, record attribute similarity, query pattern, data distribution, search terms distribution, etc.) that was not previously predicted by the model, the program code can utilize a learning agent to update the model to reflect the state of the event, in order to improve predictions in the future. Additionally, when the program code determines that a prediction (such as a predicted classification for a length L datastream signal clip) is incorrect, either based on receiving user feedback through an interface or based on monitoring related to an event, the program code updates the model to reflect the inaccuracy of the prediction for the given period of time. Program code including a learning agent cognitively analyzes any data deviating from the modeled expectations and adjusts the model to increase the accuracy of the model, moving forward.

In one or more embodiments, the program code can utilize one or more neural networks (NNs) to analyze training data and/or collected data to generate an operational machine learning model. Neural networks are a programming paradigm which enable a computer to learn from observational data. This learning is referred to as deep learning, which is a set of techniques for learning in neural networks. Neural networks, including modular neural networks, are capable of pattern (e.g., state) recognition with speed, accuracy, and efficiency, in situations where datasets are mutual and expansive, including across a distributed network, including but not limited to, cloud computing systems. Modern neural networks are non-linear statistical data modeling tools. They are usually used to model complex relationships between inputs and outputs, or to identify patterns (e.g., states) in data (i.e., neural networks are non-linear statistical data modeling or decision-making tools). In general, program code utilizing neural networks can model complex relationships between inputs and outputs and identified patterns in data. Because of the speed and efficiency of neural networks, especially when parsing multiple complex datasets, neural networks and deep learning provide solutions to many problems in multi-source processing, which program code, in embodiments of the present disclosure, can utilize in implementing a machine learning model, such as described herein.

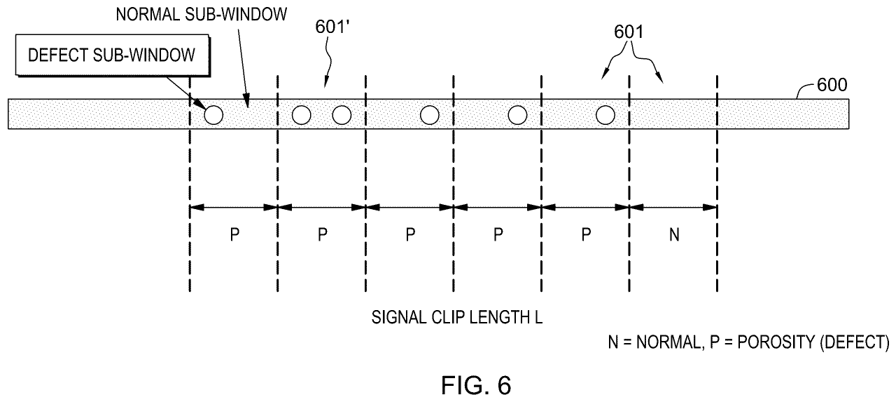

FIGS. 6-9 further illustrate implementation and use of an inference processing code and workflow, such as disclosed herein. As noted initially, current fabrication processes for, for instance, welding operations traditionally use a combination of destructive and non-destruction quality testing methods to determine whether there is a discontinuity or defect within a resultant weld. Destructive testing includes the mechanical disassembly of a weld (e.g., grinding) and chemical etching (e.g., ethanol plus citric acid) to measure fusion parameters. Where a defect is discovered using this approach, remediating the defect requires discarding any welds that have taken place from the time of the discovery to remediation. The process can thus be costly and time consuming. Non-destructive testing is largely done by human visual inspection. Occasionally, it is augmented by ultrasound testing, which is also conventionally human driven. Once a defect is discovered and remediated, each weld completed during the time at issue must also be tested.

Advantageously, the model training and inference processing disclosed herein can be used, in one or more embodiments, in association with smart edge computing to facilitate quickly detecting and correcting one or more issues with a fabrication process, such as a welding process. In one embodiment, audio and/or visual capturing technology is used to produce audio and/or visual datastream recordings taken of the fabrication process, and which can be evaluated in real-time to analyze the quality of the resultant product, for instance, the resultant weld in the case of a welding process. If the quality does not meet standards, an alert can be sent, and remediation action initiated without delay. This substantially reduces the time between detecting and remediating defects, as well as reducing the number of defects on a fabrication line, thereby providing an overall cost reduction.

By way of example, in an arc welding process, acoustic and/or visual datastream signals are captured using, for instance, one or more visual inspection cameras, such as industrial optical cameras and/or industrial thermal cameras, to visualize in-process a weld pool, wire, work piece, etc., as well as visualize heating and cooling behavior of the weld as its being produced. Acoustic analytics is also provided, in one or more embodiments, to analyze sounds of the fabrication process, such as the welding sounds. For instance, an industrial microphone can be used to listen to the arc sound in real-time. These data sources are used to generate one or more datastream signals of the fabrication process, which are then analyzed, for instance, via edge-based computing that integrates seamlessly into the fabrication process to create real-time insights, safe and secure information without ever leaving, for instance, a manufacturing facility. Cloud-based computing can also be combined with the system, such as a public, private or dedicated cloud-based deployment, to enable scalability across production lines, plants and event geographies.

To evaluate the datastream signal(s), it is desirable to divide or cut the signal(s) into a series of datastream signal clips to facilitate classification. In the welding process example, a welding defect time window is typically in the range of 50 ms to 500 ms depending on the defect type. For instance, burn-through, skip and lack-of-fusion are examples of short-term defects, and porosity, GAP, and off-location are examples of long-term defects. To implement a weld defect classification model, the length of each signal clip needs to be selected and fix. That is, the target object for classification is a series of fixed length datastream signal clips. For instance, in the inference processing described herein, datastream signal clips of length M can be defined as sub-clips or sub-windows of the larger length L datastream signal clips.

In contrast, for inference processing classification implemented on an edge-based server such as disclosed herein, the edge-based server benefits from the classify model having a longer signal-stream-to clip length for model processing efficiency, model robustness and labeling accuracy. Edge-based server response time for runtime inferencing such as disclosed herein, is advantageously at or near real-time. For a given fabrication process, such as a welding process, the longer the datastream signal clips, the smaller the number of datastream signal segments that need to be evaluated by the model, hence the higher the processing efficiency and performance that can be achieved. Further, in the case of a welding process, the welding data is often highly unbalanced, with the majority of the data being normal class data and a small portion of the data being weld defect class data. Increasing the clip length can help to effectively address this data balance issue. Further, the accuracy of the machine learning label models employed depend on the quality of the labeling, which relies on the expertise of the process professionals. However, it is challenging to pinpoint the exact location of a defect segment with a human eye, and different welding operators may use various methods to label defect segments. Allowing the welding operators to roughly indicate the defect segment for training purposes, and tolerate some normal areas being included in the defect area, assists in quickly and easily identifying and labeling defect segments. Improved labeling accuracy in turn enhances model precision, recall, robustness, and generalization ability. Therefore, disclosed herein is an inference processing and machine learning training approach which increases the clip length without loss of accuracy, and which is particularly advantageous for edge-based computing.

One solution for evaluating a fabrication process, such as a welding process, is to do datastream signal labeling using a fixed clip length M that is small enough that only one class is allowed in one datastream signal clip (e.g., normal, burn through, porosity, skip, GAP, etc. in the case of a welding process). In accordance with this disclosure, the length of the datastream signal clips being processed are increased to, for instance, a length L datastream signal clip, where L is greater than M and consists of a consecutive sequence of K signal clips of length M. This is allowed by introducing the concept of priority labeling. In priority labeling such as disclosed herein, each class is assigned a priority label, with the “normal” class label being the low priority label, and the weld defect classes each being labeled as the high priority label. Further, coexistence of low and high priority class labels within the same signal clip is allowed. In particular, the classification model algorithm disclosed herein is enhanced by allowing the low priority class to coexist with one high priority class label in a datastream signal clip. However, two different event types of the high priority class cannot coexist in the same datastream signal clip. In this manner, a maximum clip length for the length L datastream signal clip for a particular fabrication process is defined using the following rules. The length should be short enough to allow only one defect type to occur within the clip length, but not too long to allow a second defect type to occur within that length. Further, the length L of the datastream signal clip should not exceed the process (e.g., welding) duration for a specific process (e.g., weld) identification (ID). Also, the maximum clip length can vary depending on the industry, but remains fixed for a specific process, or specific machine learning model application (i.e., for the specific machine learning classification model).

By way of illustration, FIG. 6 represents a datastream signal obtained for a fabrication process (such as welding base metal), that has been divided, or cut, into a plurality of length L datastream signal clips 601, each with multiple signal clips (or sub-clips) of length M. In this example, the signal clips of length M effectively are sub-windows or sub-clips within the respective, larger length L datastream signal clip 601. FIG. 6 also illustrates a label being applied to each respective length L datastream signal clip with ‘N’ being a normal weld label and ‘P’ being a porosity type defect label. Note that in FIG. 6, length L datastream signal clip 601′ includes multiple defects of the same type, that is, multiple porosity defects ‘P’ in this example, but that each length L datastream signal clip 601 is either normal ‘N’ or includes only one type of defect ‘P’ within the clip.

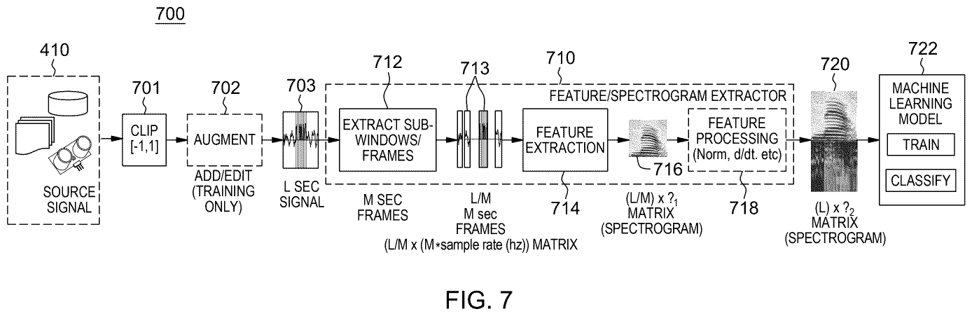

FIG. 7 depicts one embodiment of training the inference processing, including training the machine learning models to predict labels for unlabeled datastream signal clips of length M as well as to classify length L datastream signal clips using label priority, in accordance with one or more aspects of present disclosure. One or more data sources 410 include, for instance, one or more microphones, video cameras, monitoring systems, databases, etc., operatively located to obtain training and/or actual datastream signals for a fabrication process (e.g., welding process), such as one or more audio datastream signals and/or video datastream signals, for the fabrication process. Training the machine learning classify model to identify whether a length L datastream clip of the fabrication process recorded occurrence of a priority event within the fabrication process includes cutting or clipping the datastream signal into respective length L 701 signal clips, which during training can be lengthened, shortened, edited, etc., in an augmentation process 702 to generate the length L datastream signal clips 703, each of which can be a signal clip of length L seconds, and the length L datastream signal clip consists of a consecutive sequence of K signal clips of length M, where K is an integer greater than 1.

In one or more embodiments, each length L datastream signal is fed to a feature extraction and/or spectrogram extractor 710 to facilitate training the machine learning classify model to classify the length L datastream signal clips. In one or more embodiments, signal clips of length M, or sub-windows of length M, are identified 712, where M is less then L. As noted, in one or more embodiments, the length L datastream signal clip consists of a consecutive sequence of K signal clips of length M 713. In one embodiment, this can be in (L/M)×(M×Sample rate (Hertz)) matrix. Feature extraction 714 is implemented to identify the feature or label of each sub-window M via spectrogram 716 analysis. In this manner, the machine learning classify model trains on the identified features in the smaller sub-windows by implementing feature processing to identify whether there is a normal sub-window, or defect sub-window, such as described herein. In one or more embodiments, a visual image of the resultant length L datastream signal clip can be generated 720 and used with priority labeling in the trained machine learning classify model to classify the length L datastream signal clip. After training the machine learning classify model for the length L datastream signal clips 720, then during real-time operational inference processing, there is no need to divide each length L datastream signal clip into sub-windows or sub-frames M in order to classify the larger length L datastream signal clip. In one or more embodiments, the trained machine learning model can be a trained neural network, which is trained from the labeled length M spectrograms to provide the classified length L spectrograms, which are then referenced during the real-time processing of the datastream signals.

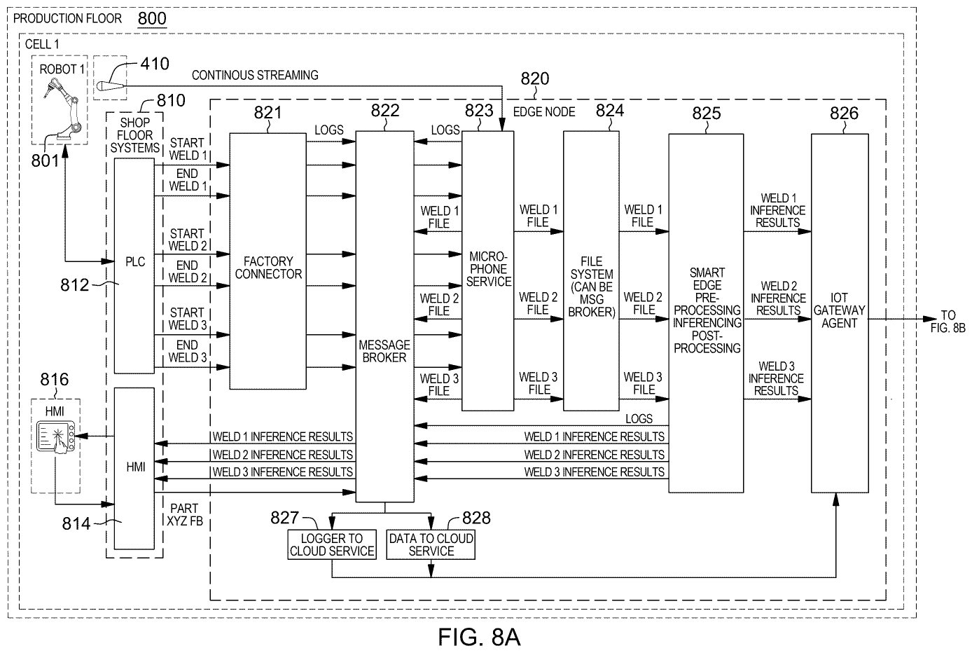

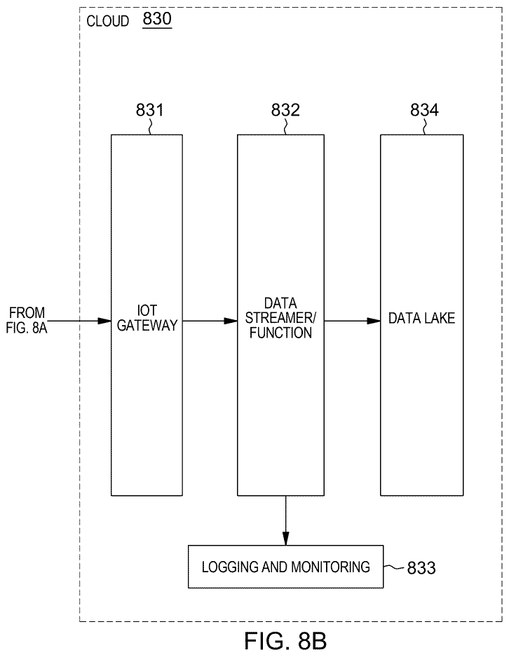

FIGS. 8A-8B depict a detailed embodiment of a fabrication process and system that includes and/or uses one or more aspects of present disclosure. In this example, a fabrication facility 800, such as a production floor, is illustrated with one or more fabrication processes, such as a robotic tool 801 implemented fabrication process, being monitored via one or more monitoring systems or data sources 410 for generating one or more datastream signals for the fabrication process. In the illustrated example, one monitoring system includes a microphone system for audio monitoring of the fabrication process. By way of example, the fabrication facility further includes one or more facility floor systems 810 which can include, for instance, a programable logic controller (PLC) 812 and a human-to-machine interface (HMI) system 814 that interfaces with, for instance, one or more operator control devices 816.

In the embodiment illustrated, fabrication facility 800 further includes an edge computing node 820 within or associated with the facility. In one embodiment, edge computing node 820 includes a factory connector 821 that receives start and end signals for a fabrication process instance, such as start and end signals for a welding process, and provides the respective signals to a message broker 822, which facilitates communication between the connector 821 and a microphone service 823, as well as a logger-to-cloud-based service 827 and forwarding of data to the cloud-based service 828, for instance, via an Internet of Things (IoT) gateway agent 826. As illustrated, the IoT gateway agent 826 is operatively in communication with an IoT gateway 831 (FIG. 8B) of a cloud-based computer resource 830, which can further include processing for datastream features and/or functions 832, and a database or data lake 834, along with logging and monitoring application code 833, as desired.

In one or more embodiments, microphone service code 823 provides various the fabrication process audio files to a file system or message broker 824 from which smart edge processing 825, including preprocessing, inferencing and postprocessing such as described herein, receives the datastream signals. In one or more use embodiments, the smart edge computing 825 provides the inference results on the different datastream signals in accordance with the trained inference processing disclosed herein. In one or more embodiments, the inference results can be used to initiate an action to, for instance, adjust one or more aspects of the fabrication process based on the results of the inferencing. For instance, in one or more embodiments, the inferencing results can be forwarded back through message broker 822 to HMI system 814 for forwarding to, for instance, user interface 816 and/or for facilitating direct communication and adjustment of the fabrication tool 801.

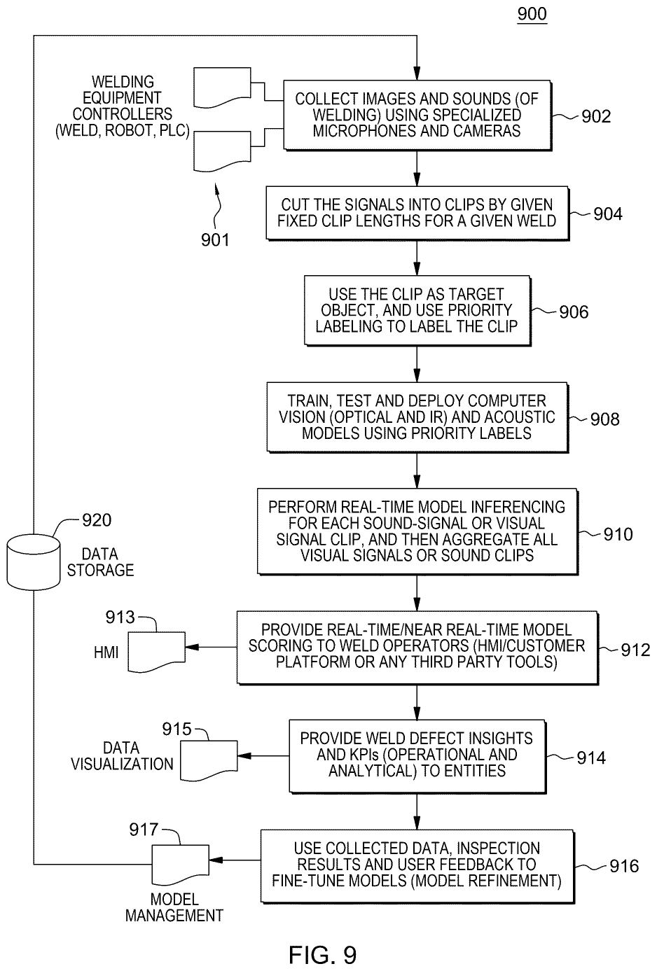

By way of further example, FIG. 9 depicts another embodiment of an interference processing workflow, in accordance with one or more aspects of the present disclosure. As illustrated, inference processing workflow 900 includes obtaining data, including one or more datastream signals such as described herein, such as from one or more facility process tools, such as one or more welding equipment controllers including, for instance, a robotic welder, programed logic controller (PLC), etc. 901 in the case of a welding process. For instance, the workflow 900 collects video datastream signals and/or audio datastream signals of the fabrication process (e.g., welding process) using, for instance, one or more monitoring systems including, for instance, specialized microphones and/or cameras depending on the process 902. The datastream signals are cut, segmented, divided, etc., into fixed length L datastream signal clips for a given fabrication process (e.g., for a given weld) 904. Using the length L datastream signal clip as a target object, priority labeling is implemented as described herein to label the datastream clip 906. In one or more embodiments, the workflow can include training, testing and deploying computer vision (e.g., optical and/or infrared vision) classify models and an acoustic classify model using the priority labels obtained for the datastream signal clips 908. The process workflow further includes, in one embodiment, performing real-time model inferencing for each datastream signal clip, and then aggregating the datastream signal clips (i.e., visual or sound clips) 910. Further, in one or more use embodiments, the process includes providing real-time and/or near real-time model scoring, or prioritized labeling, to an operator, such as a fabrication process operator (e.g., human-to-machine interface (HMI) 913 and/or facility platform or other third party computing tools) as desired to document the fabrication process and/or implement an automated adjustment to the fabrication process based on the inference results. In the case of a welding process, any weld defect insights and key performance indicators (KPIs) (operational and analytical) can be provided to the fabrication process engineering systems and/or quality team system(s) 914, to facilitate data display and visualization 915. In one embodiment, this can include providing one or more graphs illustrating, for instance, one or more detected defects. In one embodiment, the workflow further includes using the collected data, inspection results, and/or user feedback to fine tune one or more of the machine learning models 916 to implement model management 917, with the refined machine learning model(s) being stored in data storage 920 for use in further inference processing workflows, such as described herein.

As noted herein, systems and methods for training and tuning acoustic and/or visual datastream signal classification models are disclosed herein in which a set of classification models is applied to a set of acoustic or video datastream signal samples to identify defect events, such as welding defect events in the case of a welding process. The labels have priorities with respect to each other. A machine learning classify model that has a sub-widow segment structure is defined and trained that incorporates label priority. In embodiments, the machine learning model is trained, in part, to predict unprioritized labels using labeled datastream signal clips of length M. The machine learning model training, including signal feature extraction and pre-processing to build a spectrogram, is performed using the labeled clips. This results in a model that can predict labels for unlabeled signal clips of length M. The trained machine learning classify model, or ensemble algorithm, is used to label a signal clip of length L (where L≥M), consisting of a sequence of K signal clips of length M. The classify model applies the machine learning label model to the K signal clips of length M to create a list of K labels assigned to the K signal clips. The classify algorithm or model applies label priority processing to select a most appropriate label from among the list of K labels to apply to the larger length L datastream signal clip, as disclosed herein. Note that, in one or more embodiments, an optimal training signal clip length is also identified to produce an optimal classify model, as measured by one or more model accuracy metrics.

In one or more embodiments, the labeling of the datastream signal clips of length M used to train the machine learning model can be performed by a human to, for instance, identify the start and stop points within a clip of a specific event. As disclosed, one of the event labels can have a lower priority class, and all other event labels have an equal, higher priority class. The clip length L is grown to include only one type of the higher priority class labels. The classify model, or ensemble algorithm, can apply the label priority in various ways, including prioritization, voting, weighting, longest sequence, etc., as desired for a particular application. Cross-validation of the trained models with different fixed clip lengths can also be performed, in one or more embodiments, to identify the clip length that results in the highest accuracy model on the higher priority labels.

In embodiments, label priority is applied in the classify model, or ensemble algorithm, where within a clip length, a higher priority label overrides the lower priority label of a sub-window, such that if both the lower priority class label and a higher priority class label exists in the same clip length L, only the higher priority class label is selected for labeling that clip length (i.e., the length L datastream signal clip). In the case of acoustic or visual stream signal classification such as described herein, a “normal” class can be assigned the lower priority label and any defect classes (such as burn-through, porosity, skip, GAP, off-location, etc., in the case of the weld defect implementation) are assigned equally the higher priority class label.

In embodiments, the system allows the lower priority label to coexist with one type of higher priority class label, which provides several benefits. For instance, there is no need to distinguish small gaps between a normal class and defect class, simplifying the labeling process. Direct labeling an entire mixed signal segment as, for instance, the high priority class label is acceptable. Further, allowing the higher priority labeled clips to include the normal class sub-windows, extends the overall clip length of the resultant length L datastream signal clip, which helps alleviate data imbalance issues. In one or more embodiments, the system has an upper limit for a signal clip length, with the maximum clip length being defined by one or more rules. For instance, the clip length should be short enough to allow only one defect to occur within the clip length, but not too long to allow other defects to also occur. Further, the clip length should not exceed the fabrication process duration, such as the welding duration that the arc welding control parameter changes (e.g., two seconds). In embodiments, the inferencing system and process disclosed herein leverages a particular architecture to interpret acoustic inputs as well as visual inputs. Further, the inferencing process can classify and prioritize defects in a multi-modal model running at an edge computing node (e.g., at an edge-based computer). The classification, prioritization and scoring are all accomplished in real-time during the fabrication process (e.g., during a weld pass in the case of a welding process).

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally, or alternatively, the service provider may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer-readable code into a computing system, in which the code in combination with the computing system is capable of performing one or more embodiments.

Yet a further aspect, a process for integrating computing infrastructure comprising integrating computer-readable code into a computer system may be provided. The computer system comprises a computer-readable medium, in which the computer medium comprises one or more embodiments. The code in combination with the computer system is capable of performing one or more embodiments.

Although various embodiments are described above, these are only examples. For example, other models and/or data may be used. Moreover, additional, less and/or other code may be used. Although particular code may be provided as an example of performing a particular operation or task, additional and/or other code may be used. Code may be combined and/or separated into code subsets. Many variations are possible.

Various aspects and embodiments are described herein. Further, many variations are possible without departing from a spirit of aspects of the present disclosure. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A method comprising:
training a machine learning classify model to identify whether a length L datastream clip of a fabrication process recorded occurrence of a priority event within the fabrication process, wherein training the machine learning classify model comprises:
training a machine learning label model to predict labels for unlabeled datastream signal clips of length M obtained for the fabrication process, where L is greater than M and consists of a consecutive sequence of K signal clips of length M, and wherein training the machine learning label model uses labeled datastream signal clips of length M;
applying the trained machine learning label model to the length L datastream signal clip for the fabrication process to create a list of labels for the consecutive sequence of K signal clips of the length L datastream signal clip; and
applying label priority to select a most appropriate label from among the list of labels to apply to the length L datastream signal clip, wherein the selected label for the length L datastream clip identifies whether the length L datastream signal clip recorded occurrence of a priority event within the fabrication process.

2. The method of claim 1, wherein the list of labels includes an event label that has a lower priority class than another event label of higher priority class in the list of labels, and wherein the selected label comprises the other event label of higher priority class in the list of labels.

3. The method of claim 2, wherein the event label of lower priority class is a normal process event label, and the other event label of higher priority class is a defect event label of a plurality of defect event labels of the higher priority class.

4. The method of claim 3, wherein the fabrication process comprises a welding process, and the plurality of defect event labels of the higher priority class represent different types of weld defects.

5. The method of claim 1, wherein training the machine learning classify model further comprises:
receiving a datastream signal for the fabrication process; and
identifying a size of the length L datastream signal clip for the received datastream signal.

6. The method of claim 5, wherein the identifying includes optimizing the size of the length L datastream signal clip by growing the size of the length L datastream signal clip while including only one event label type of a higher priority class of a plurality of event label types of the higher priority class, wherein optimizing the size of the length L datastream signal clip produces an optimal machine learning classify model as measured by a model accuracy metric.

7. The method of claim 6, wherein the received datastream signal is selected from the group consisting of an audio datastream signal of the fabrication process and a video datastream signal of the fabrication process.

8. The method of claim 1, wherein training the machine learning classify model further comprises dynamically determining a size of the length L datastream signal clip, the dynamically determining ensuring that only one type of priority event is within the length L datastream signal clip, wherein the one type of priority event is one type of priority event of a plurality of types of priority events monitored for during the fabrication process.

9. The method of claim 1, wherein training the machine learning label model includes using the labeled datastream signal clips of length M in facilitating signal feature extraction and pre-processing to build spectrograms for the unlabeled datastream signal clips of the length M to assist in predicting the labels for the unlabeled datastream signal clips of length M.

10. A computer program product comprising:
one or more computer-readable storage media; and
program instructions stored on the one or more computer-readable storage media to perform operations comprising:
training a machine learning classify model to identify whether a length L datastream clip of a fabrication process recorded occurrence of a priority event within the fabrication process, wherein training the machine learning classify model comprises:
training a machine learning label model to predict labels for unlabeled datastream signal clips of length M obtained for the fabrication process, where L is greater than M and consists of a consecutive sequence of K signal clips of length M, and wherein training the machine learning label model uses labeled datastream signal clips of length M;
applying the trained machine learning label model to the length L datastream signal clip for the fabrication process to create a list of labels for the consecutive sequence of K signal clips of the length L datastream signal clip; and
applying label priority to select a most appropriate label from among the list of labels to apply to the length L datastream signal clip, wherein the selected label for the length L datastream clip identifies whether the length L datastream signal clip recorded occurrence of a priority event within the fabrication process.

11. The computer program product of claim 10, wherein the list of labels includes an event label that has a lower priority class than another event label of higher priority class in the list of labels, and the selected label comprises the other event label of higher priority class in the list of labels, and wherein the event label of lower priority class is a normal process event label, and the other event label of higher priority class is a defect event label of a plurality of defect event labels of the higher priority class.

12. The computer program product of claim 11, wherein the fabrication process comprises a welding process, and the plurality of defect event labels of the higher priority class represent different types of weld defects.

13. The computer program product of claim 10, wherein training the machine learning classify model further comprises:
receiving a datastream signal for the fabrication process; and
identifying a size of the length L datastream signal clip for the received datastream signal.

14. The computer program product of claim 13, wherein the identifying includes optimizing the size of the length L datastream signal clip by growing the size of the length L datastream signal clip while including only one event label type of a higher priority class of a plurality of event label types of the higher priority class, wherein optimizing the size of the length L datastream signal clip produces an optimal machine learning classify model as measured by a model accuracy metric.

15. The computer program product of claim 10, wherein training the machine learning classify model further comprises dynamically determining a size of the length L datastream signal clip, the dynamically determining ensuring that only one type of priority event is within the length L datastream signal clip, wherein the one type of priority event is one type of priority event of a plurality of types of priority events monitored for during the fabrication process.

16. The computer program product of claim 10, wherein training the machine learning label model includes using the labeled datastream signal clips of length M in facilitating signal feature extraction and pre-processing to build spectrograms for the unlabeled datastream signal clips of the length M to assist in predicting the labels for the unlabeled datastream signal clips of length M.

17. A computer system comprising:
a processor set;
one or more computer-readable storage media; and
program instructions stored on the one or more computer-readable storage media to cause the processor set to perform operations comprising:
training a machine learning classify model to identify whether a length L datastream clip of a fabrication process recorded occurrence of a priority event within the fabrication process, wherein training the machine learning classify model comprises:
training a machine learning label model to predict labels for unlabeled datastream signal clips of length M obtained for the fabrication process, where L is greater than M and consists of a consecutive sequence of K signal clips of length M, and wherein training the machine learning label model uses labeled datastream signal clips of length M;
applying the trained machine learning label model to the length L datastream signal clip for the fabrication process to create a list of labels for the consecutive sequence of K signal clips of the length L datastream signal clip; and
applying label priority to select a most appropriate label from among the list of labels to apply to the length L datastream signal clip, wherein the selected label for the length L datastream clip identifies whether the length L datastream signal clip recorded occurrence of a priority event within the fabrication process.

18. The computer system of claim 17, wherein the list of labels includes an event label that has a lower priority class than another event label of higher priority class in the list of labels, and wherein the selected label comprises the other event label of higher priority class in the list of labels, and wherein the event label of lower priority class is a normal process event label, and the other event label of higher priority class is a defect event label of a plurality of defect event labels of the higher priority class.

19. The computer system of claim 18, wherein the fabrication process comprises a welding process, and the plurality of defect event labels of the higher priority class represent different types of weld defects.

20. The computer system of claim 17, wherein training the machine learning classify model further comprises dynamically determining a size of the length L datastream signal clip, the dynamically determining ensuring that only one type of priority event is within the length L datastream signal clip, wherein the one type of priority event is one type of priority event of a plurality of types of priority events monitored for during the fabrication process.
